(19) United States
(12) Patent Application Publication
(10) Pub. No.: US 2006/0222530 A1
(43) Pub. Date: Oct. 5, 2006

(54) Compressor

(76) Inventor: Shao-Shih Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/014,978

(22) Filed: Dec. 20, 2004

(51) Int. Cl. H02K 9/06; F04B 35/04

(52) U.S. Cl. 417/415; 310/63

(57) ABSTRACT

A compressor includes a motor, side covers, cylinder sets and fans. The motor includes a rotor and a coil at either side. The rotor is provided with blades secured in the coil. Each side cover comprises a side plate. The side plate has air inlets and a rim corresponding to the rotor of the motor. Each side cover is mounted on the motor with the rim engaging with the inner rim of the coil to form a guiding section. When the fan rotates, the blades of the rotor guide the wind towards the coil to radiate heat.

### BACKGROUND OF THE INVENTION

1. Field of the Invention

This invention relates to a compressor, and more particularly to a compressor to guide wind toward a rotor of a motor to radiate heat from the motor.

2. Description of the Related Art

A conventional compressor A, as shown in FIGS. 5 and 6, comprises a motor B and a pair of side covers C secured at two ends of the motor B. The motor B comprises a rotor B1 and a coil B2 at either side. Each side cover C has a cylinder base C1 to secure a cylinder set C2 thereat. The side cover C comprises a side plate C3 which comprises a bearing seat C31 with a bearing C32 therein corresponding to the spindle B11 of the rotor B1 of the motor B. A number of air inlets C33 are provided on the side plate C3. A number of air outlets C4 are formed on the side cover C. A fan D is set at one end of the side cover C. The fan D inhales air outside and blows the air towards the cylinder set C2 and the motor B to cool down the heat.

The side plates C3 of the side cover C remains a distance from the rotor B1 of the motor B. This distance is too far away from each other. In addition, each air inlet C33 has a big opening. The wind blowing into the motor B causes turbulence, which decreases the effect of radiation heat.

### SUMMARY OF THE INVENTION

It is the primary objective of the present invention to provide a compressor, which is capable of radiating heat in less time.

It is another objective of the present invention to provide the compressor, which is more efficient.

It is a further objective of the present invention to provide the compressor, which has a longer life span.

### BRIEF DESCRIPTION OF THE DRAWINGS

FIG. 1 is an exploded view of the present invention;

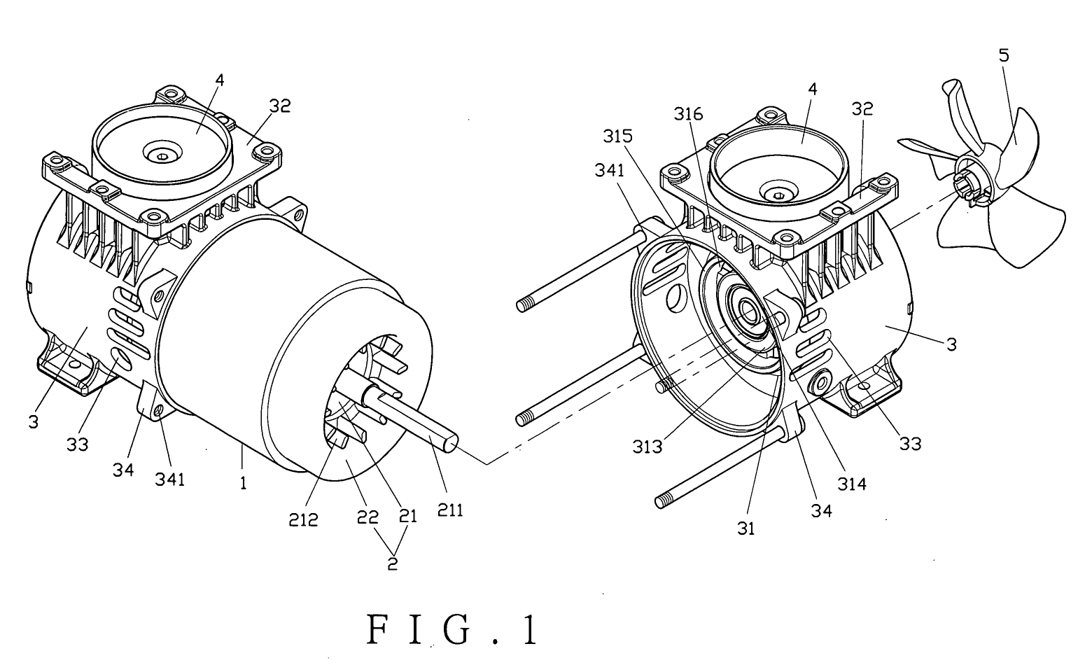

FIG. 2 is a cross-sectional view of the present invention;

FIG. 3 is a side view of the present invention in an operation status, partially sectioned;

FIG. 4 is a partially sectional view depicting wind current flowing in the compressor;

FIG. 5 is a cross-sectional view of a prior art; and

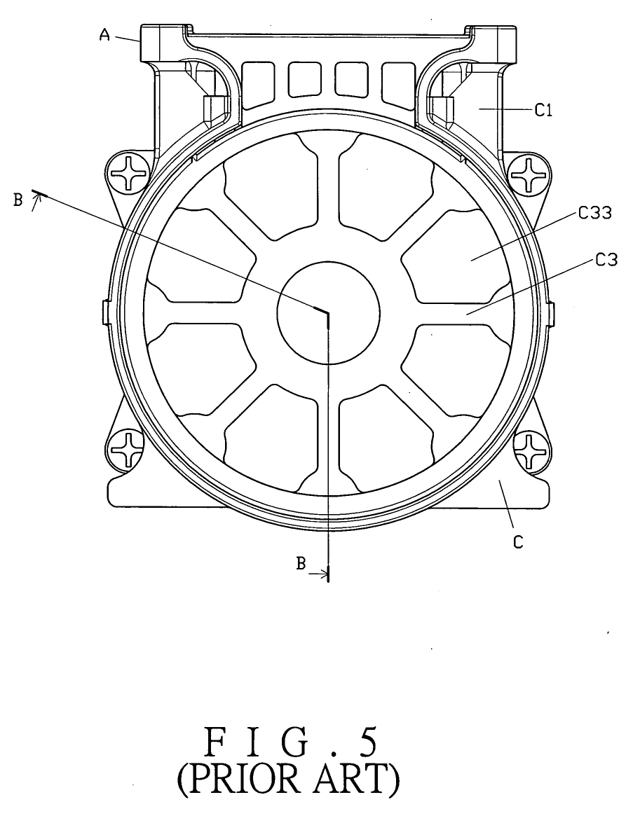

FIG. 6 is a side-sectional view of the prior art in an operation status, partially sectioned.

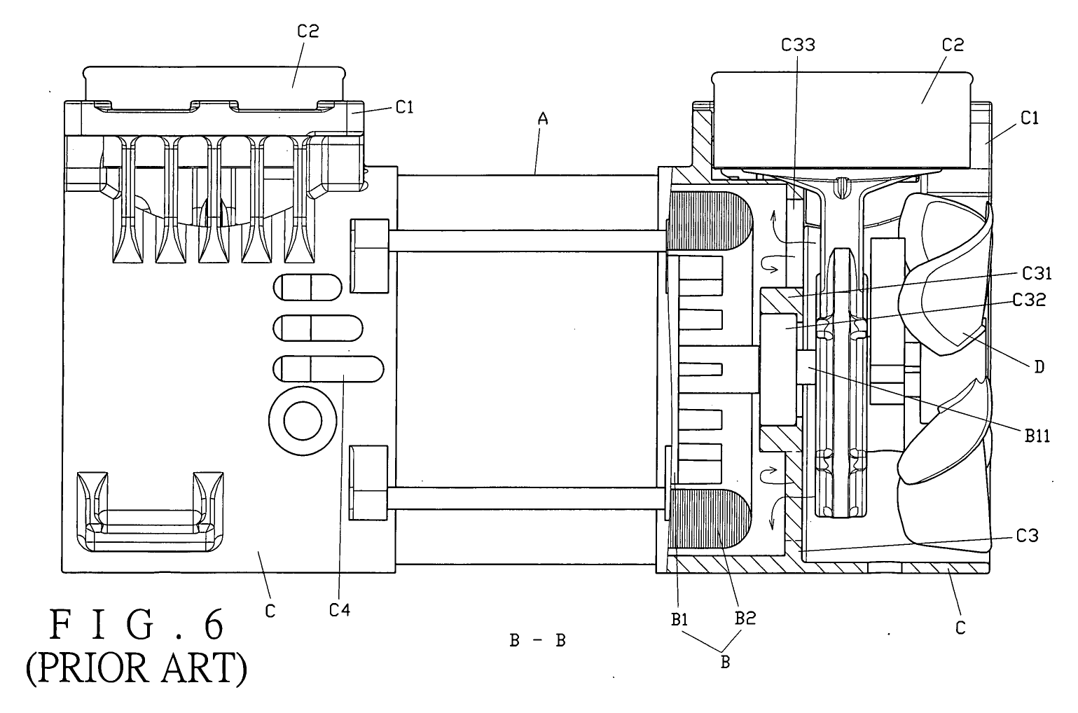

### DETAILED DESCRIPTION OF THE PREFERRED EMBODIMENT

A compressor 1 of the present invention comprises a motor 2, a pair of side covers 3, a pair of cylinder sets 4, and a pair of fans 5.

The motor 2 comprises a rotor 21 and a coil 22 at either side. The rotor 21 is secured in the coil 22 with a spindle 211 extending from the rotor 21. A plurality of blades 212 is provided around the rotor 21.

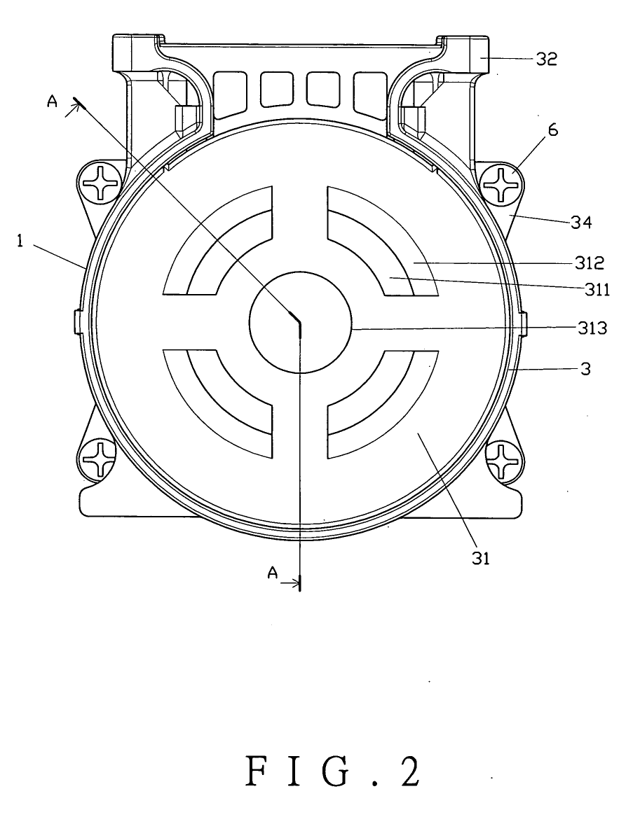

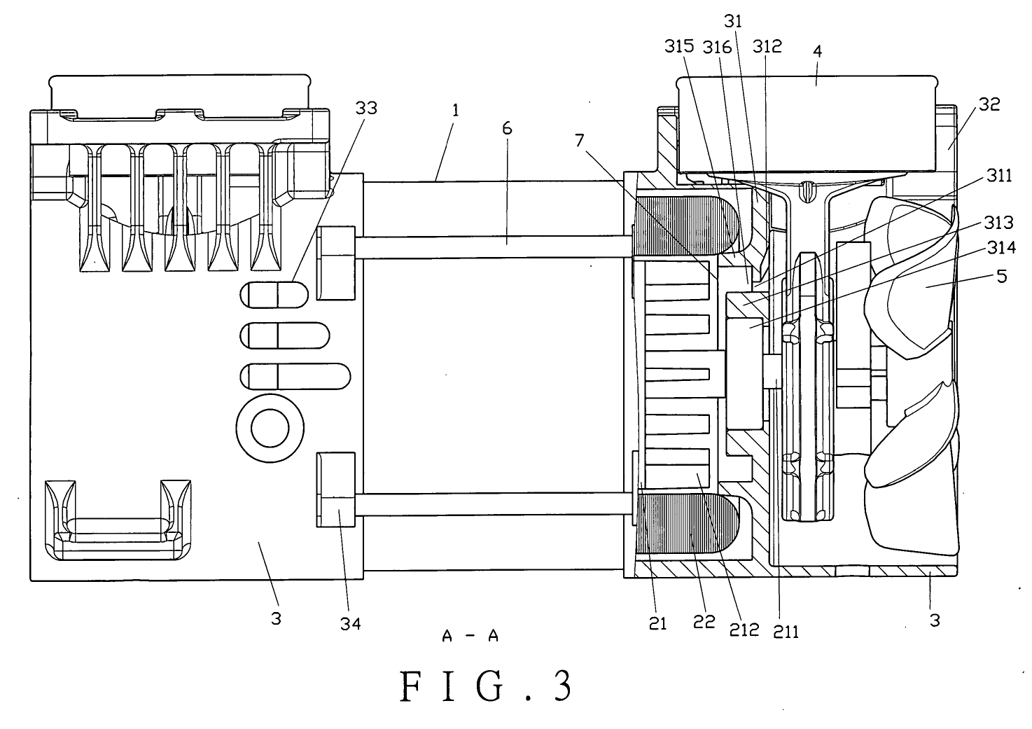

Each side cover 3 is a hollow body, as shown in FIGS. 2 and 3, and comprises a side plate 31 therein. The side plate 31 has a plurality of air inlets 311 thereon. Each air inlet 311 has a guiding surface 312 on its outer surface. A bearing seat 313 secured with a bearing 313 is formed on the side plate 31 in correspondence with the rotor 21 of the motor 2 for the spindle 211 of the rotor 21 of the motor 2 to extend there through. The side plate 31 in relation to the rotor 21 of the motor 2 has a rim 315. A guiding trough 316 interconnected with the air inlet 313 is formed between the rim 315 and the bearing seat 313. The guiding trough 316 has a width equal to that of the air inlet 311. Furthermore, the top end of the side cover 3 is formed with a cylinder base 32 to secure the cylinder set 4 thereat. The side cover 3 further comprises a plurality of radiating holes 33 at two outer sides and a plurality of lugs 34. Each lug 34 is formed with a hole 341 thereon.

Each cylinder set 4 is secured on the cylinder base 32 of each side cover 3, and is activated by the motor 2.

Each fan 5 is secured in the respective side cover 3, and is activated by the rotor 21 of the motor 2 to suck the air outside into the motor 2.

To assemble the present invention, as shown in FIG. 3, a number of bolts 6 are inserted through the holes 341 of the lugs 34 of the two side covers 3 to secure the side covers 3 to the two sides of the motor 2 with the spindle 211 of each rotor 21 of the motor 2 extending through the bearing seat 313 of each side cover 3. The rim 315 of the side plate 31 engages with the inner rim of the coil 22 to form a guiding section 7. The cylinder 4 and the fan 5 are secured on the spindle 211 of the rotor 21 protruding from the side cover 3, and are activated with the rotor 21 of the motor 2 simultaneously.

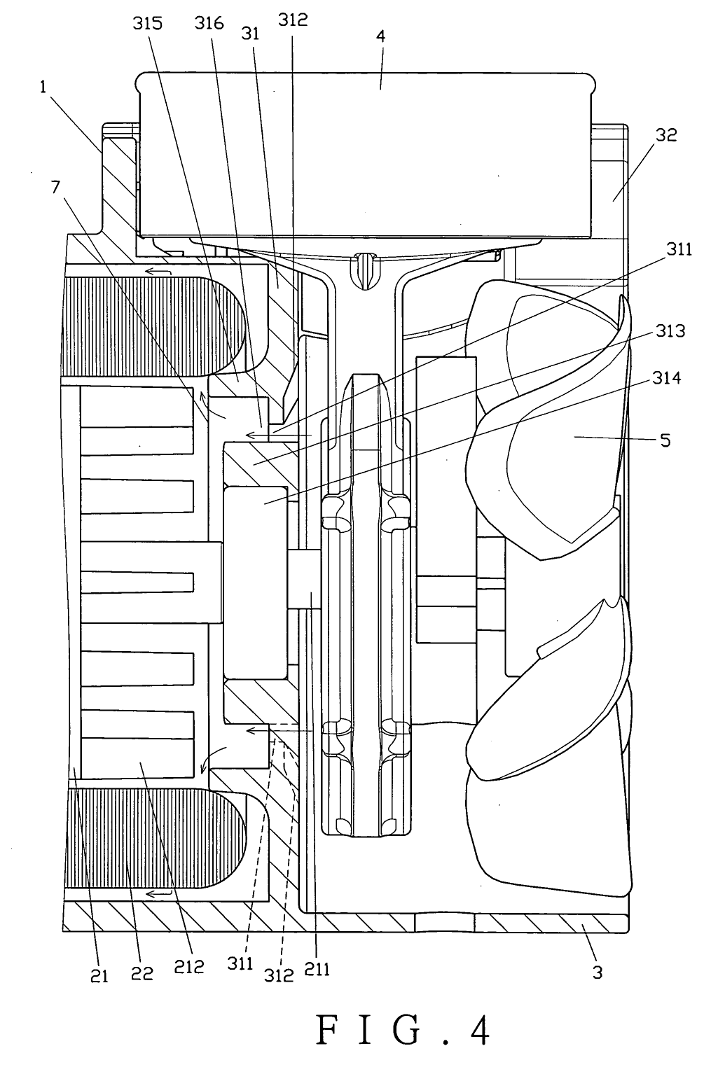

In practice, as shown in FIG. 4, the fan 5 is activated by the spindle 211 of the rotor 21 to rotate to suck air from the air inlets 311 of the side plate 31. The air flows along the guiding surfaces 312 through the air inlets 311 of the side cover 3 into the guiding trough 316. Owing to the engagement of the rim 315 and the coil 22, wind is collected in the guiding section 7, while the blades 211 of the rotor 21 starts to spin to suck the air from the air inlets 311 of the side cover 3. Thus the wind collected in the guiding section 7 is guided by the air from the movement of the blades 211 towards the coil 22 to radiate heat.

Because the guiding section 7 is confined, the wind can be collected in an efficient way to cool the coil 22 of the motor 2, and expelled through the radiating holes 33 of the side cover 3 in a rapid way.

I claim:

1. A compressor comprises a motor, a pair of side covers, a pair of cylinder sets, and a pair of fans, said motor comprising a rotor and a coil at either side, said rotor comprising blades secured in said coil, each side cover comprising a side plate, and characterized in that:
said side plate of each side cover comprising a plurality of air inlets and a rim corresponding to said rotor of said motor;
thereby each side cover secured on said motor, said rim of said side cover engaging with an inner rim of said rotor to form a guiding section.

2. The compressor, as recited in claim 1, where each air inlet of said side cover comprises a guiding surface on its outer surface.
